(19) United States
(12) Patent Application Publication
(10) Pub. No.: US 2005/0160362 A1
(43) Pub. Date: Jul. 21, 2005

(54) Systems and methods for performing variable data printing

(76) Inventors: Petar Obradovic, Vancouver, WA (US); Donald R. Abel, Sherwood, OR (US); Ouri Poupko, Nes-Ziona (IL); Steven P. Hiebert, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/759,866

(22) Filed: Jan. 15, 2004

(51) Int. Cl. G06F 15/00

(52) U.S. Cl. 715/527

(57) ABSTRACT

Systems for performing variable data printing are provided. An exemplary system includes a dynamic variable data print (VDP) workflow system operative to receive information corresponding to independent portions of a VDP campaign. The VDP campaign includes a design portion, a rules portion and a variable data portion. The dynamic VDP workflow system is also operative to combine the information received to form a Personalized Print Markup Language Template (PPMLT) print job. Methods also are provided.

### TECHNICAL FIELD

The invention generally relates to digital printing and related methods.

### DESCRIPTION OF THE RELATED ART

In a variable data print (VDP) campaign, hardcopy, e.g., an advertising brochure, is produced that includes variable data. Variable data enhances the hardcopy by personalizing the content for the intended recipients. Specifically, the variable data is placed within copy holes defined on the hardcopy, with the copy holes being based upon a set of rules that govern the VDP campaign. By way of example, a rule may include placing variable data within a copy hole based on the age of the intended recipient of the hardcopy. Thus, in the event that the intended recipient is over fifty-five years of age, the variable data placed within the copy hole might include information about travel activities. In contrast, if the intended recipient is a teenager, the variable data placed within the copy hole might include information about various universities.

As should be understood, implementing a VDP campaign can be very complex. Typically, a single, highly-specialized person is used to manage and/or create multiple aspects of a VDP campaign. Since persons with the required level of specialized knowledge are somewhat rare, this person can become a workflow bottleneck in the implementation of VDP campaigns.

### SUMMARY

Systems and methods for performing variable data printing are provided. In this regard, an embodiment of a system comprises: a dynamic variable data print (VDP) workflow system operative to receive information corresponding to independent portions of a VDP campaign, the VDP campaign comprising a design portion, a rules portion and a variable data portion, the dynamic VDP workflow system being further operative to combine the information received to form a Personalized Print Markup Language Template (PPMLT) print job.

An embodiment of a method for performing variable data printing comprises: defining independent portions of a variable data print (VDP) campaign such that the VDP campaign includes a design portion, a rules portion and a variable data portion; and defining inputs and outputs associated with each of the portions of the VDP campaign.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram depicting an embodiment of a variable data print (VDP) campaign that is separated into discrete portions for forming a VDP print job.

FIG. 2 is flowchart depicting functionality of the embodiment of the VDP campaign of FIG. 1.

FIG. 3 is a schematic diagram depicting the variable data portion, rules portion, and design portion of an embodiment of a VDP campaign showing representative inputs and outputs associated with each portion.

FIG. 4 is a schematic diagram depicting an embodiment of a VDP campaign management system.

FIG. 5 is a schematic diagram of a computer or processor-based device shown implementing an embodiment of a dynamic VDP workflow system.

FIG. 6 is a flowchart depicting functionality of the embodiment of the dynamic VDP workflow system of FIG. 5.

### DETAILED DESCRIPTION

As will be described in detail here, systems and methods for performing variable data printing are provided that can potentially improve the efficiency of the workflow process for implementing a variable data print (VDP) campaign. Specifically, several embodiments will be described herein that include discretely defined portions of a VDP campaign. By way of example, these portions can include a design portion, which typically involves work provided by a graphic artist, a rules portion, which typically involves work provided by a marketing department, and a variable data portion, which typically includes information provided by a database administrator and/or information technologist. By specifically defining the inputs and outputs associated with each of the portions of a VDP campaign, the functions associated with each of the portions can be separately performed and then merged when the required outputs are received to form a print job.

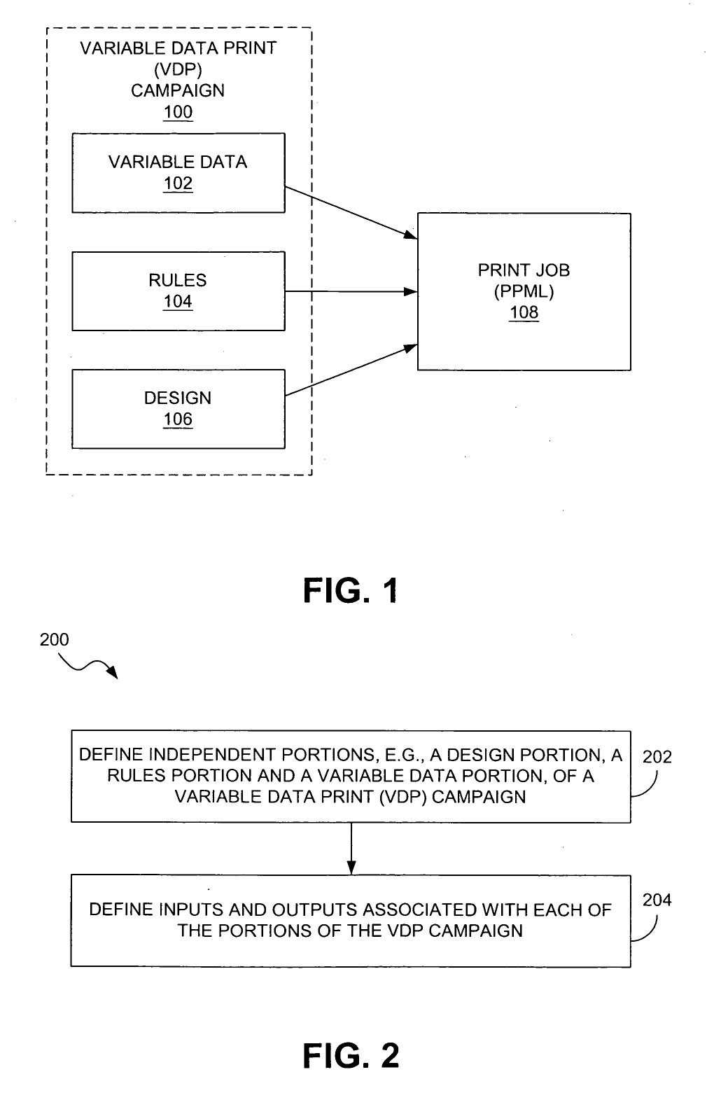

Referring now to the drawings, FIG. 1 is a schematic diagram depicting an embodiment of a VDP campaign. In particular, VDP campaign 100 includes a variable data portion 102, a rules portion 104, and a design portion 106. Information associated with each of the variable data portion 102, the rules portion 104, and the design portion 106 is combined to form a print job 108. Typically, the print job is merged from the various portions as a Personalized Print Markup Language Template (PPMLT) file that can be converted to a Personalized Print Markup Language (PPML) file. Such a PPML file can be used by a digital printing device (not shown in FIG. 1) to produce hardcopy associated with the VDP campaign. More information regarding PPML and PPMLT is available at the respective specifications, each of which is incorporated by reference herein.

Reference will now be made to the flowchart of FIG. 2, which depicts the functionality associated with the VDP campaign 100 of FIG. 1. As shown in FIG. 2, the functionality (or method) 200 may be construed as beginning at block 202, where independent portions of a VDP campaign are defined. For example, the portions can include a design portion, a rules portion, and a variable data portion. In block 204, inputs and outputs (or interfaces) associated with each of the portions of the VDP campaign are defined.

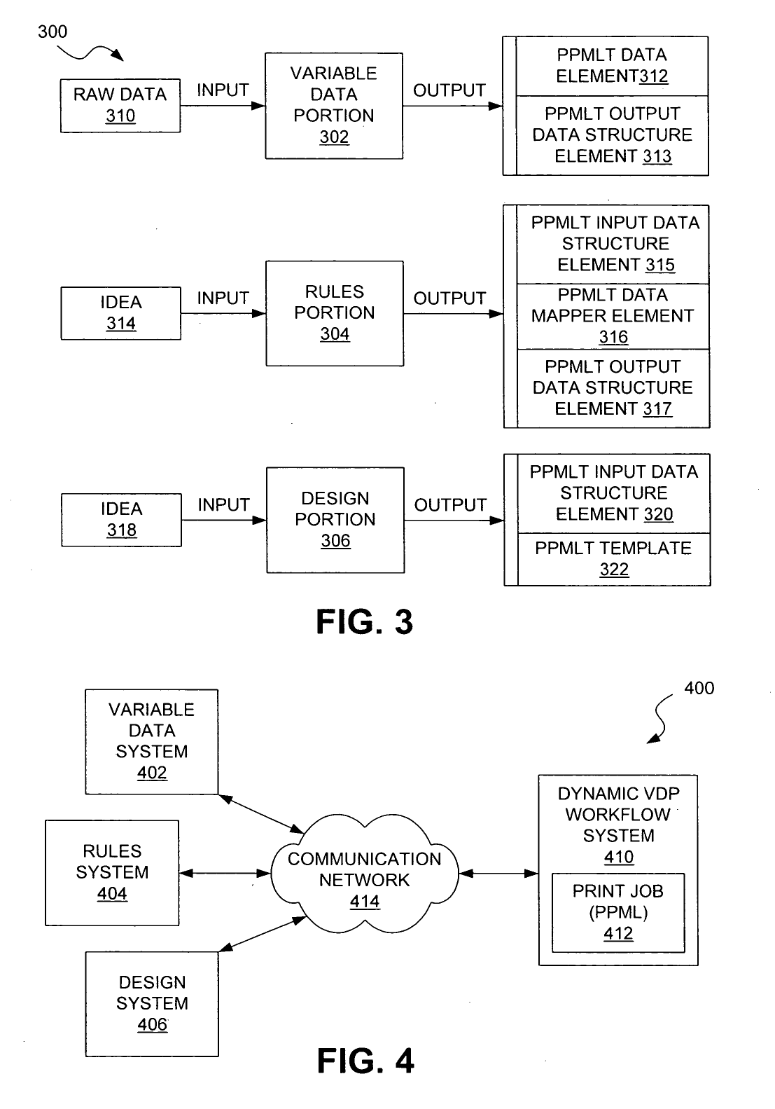

A schematic diagram detailing exemplary inputs and outputs of representative portions of an embodiment of a VDP campaign is presented in FIG. 3. As shown in FIG. 3, VDP campaign 300 includes a variable data portion 302, a rules portion 304, and a design portion 306. The variable data portion of a VDP campaign typically involves accessing raw data that will be used by the VDP campaign. As depicted in FIG. 3, raw data 310, which can be in the form of a database, is provided as an input to the variable data portion 302. The variable data portion 302, i.e., the system(s) implementing the functionality associated with the variable data portion, outputs a PPMLT data element 312 and a PPMLT OUTPUT_DATA_STRUCTURE element 313. The PPMLT data element contains the database records that are to be merged with a PPMLT template to generate personalized instance documents, i.e., hardcopy containing selected portions of the variable data. The PPMLT DATA_STRUCTURE element 313 describes the format of the data, such as by using Extensible Markup Language (XML) Schema.

The rules portion 304 of VDP campaign 300 also receives an input. In this case, the input to rules portion 304 is an idea 314. Typically, such an idea is provided by a marketing manager, whose job it is to provide business logic so that the data provided by the variable data portion can be effectively used in the VDP campaign. By way of example, idea 314 can involve providing a discount coupon to customers based on previous purchases from a company. For instance, customers who have purchased more than $500.00 of equipment can be designated for receiving a twenty percent discount coupon, customers who have purchased between $250.00 and $500.00 of equipment can be designated for receiving a fifteen percent discount coupon, and customers who have purchased less than $250.00 of equipment can be designated to receive a ten percent coupon. This logic is embodied in one or more rules that can be provided as algebraic expressions, for example.

In the example of FIG. 3, rules portion 304 receives idea 314 as input and, in response thereto, outputs a PPMLT INPUT_DATA_STRUCTURE element 315, a PPMLT DATA_MAPPER element 316, and a PPMLT OUTPUT_DATA_STRUCTURE element 317. The PPMLT DATA_MAPPER element contains a script designed to reformat the input data, with the input and output data structure elements 315 and 317 defining the format of the input and output data, respectively. By way of example, input and output data structure elements 315 and 317 can express the data formats in XML Schema.

When data is received by the data mapper element 316, the data mapper element reformats the data. Specifically, the result of applying a data mapper element to the data is an appropriately formatted input to a PPMLT template.

With respect to design portion 306, an idea 318 also is shown being input in FIG. 3. Such an idea expresses the general look and feel of the print job. Typically, the idea 318 is reduced to a design that includes static parts, which do not change between document instances, and placeholders, which are to be filled using the variable data, for example.

After using the idea 318 and an appropriate design application to create the design, design portion 306 outputs a PPMLT INPUT_DATA_STRUCTURE element 320 and a PPMLT template 322. The data structure element 320 is used to describe the structure of the variable data that is to be used in the PPMLT template, and can be described in XML Schema, for example. The PPMLT template identifies a prototype PPML document that is used to generate a PPML instance document. As mentioned before, a PPML instance document is a PPML file used by a digital printing device to create a hardcopy document of a VDP campaign.

Reference will now be made to FIG. 4, which is a schematic diagram of an embodiment of a VDP campaign management system 400 that includes an embodiment of a variable data system 402, an embodiment of a rules system 404, and an embodiment of a design system 406. VDP campaign management system 400 also incorporates an embodiment of a dynamic VDP workflow system 410 that receives information corresponding to the various portions of a VDP campaign and enables a VDP print job to be provided. In the embodiment of FIG. 4, an exemplary print job 412 is depicted that is provided in PPML format after being converted from PPMLT.

In order to receive the information corresponding to the various portions of the VDP campaign, the dynamic VDP workflow system 410 communicates with each of the variable data system 402, the rule system 404 and the design system 406 via a communication network 414. Although depicted as separate computer systems, more than one of the variable data system, the rules system, and the design system could be provided by a single computer, for example. Note, communication network 414 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

The variable data system 402, the rules system 404 and the design system 406 are able to interface with each other in a manner facilitated by the dynamic VDP workflow system 410. Specifically, each of the various systems of the VDP campaign can receive inputs that were previously stored in accordance with instructions provided by the dynamic VDP workflow system. Additionally, outputs provided by each of the various systems also can be provided to the dynamic VDP workflow system, with the outputs being stored for later use. For instance, the stored information could be accessed, as needed, and used as the inputs to another portion (system) of the VDP campaign management system.

Once all of the various information is acquired by the dynamic VDP workflow system 410, the print job 412 can be completed, such as by providing the required PPML file(s) to a digital printing device (not shown in FIG. 4).

Functionality associated with one or more of the portions (systems) of a VDP campaign management system, e.g., a rules portion and/or a dynamic VDP workflow system, can be implemented in software, firmware, hardware, or combinations thereof. When implemented in hardware, such a system can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

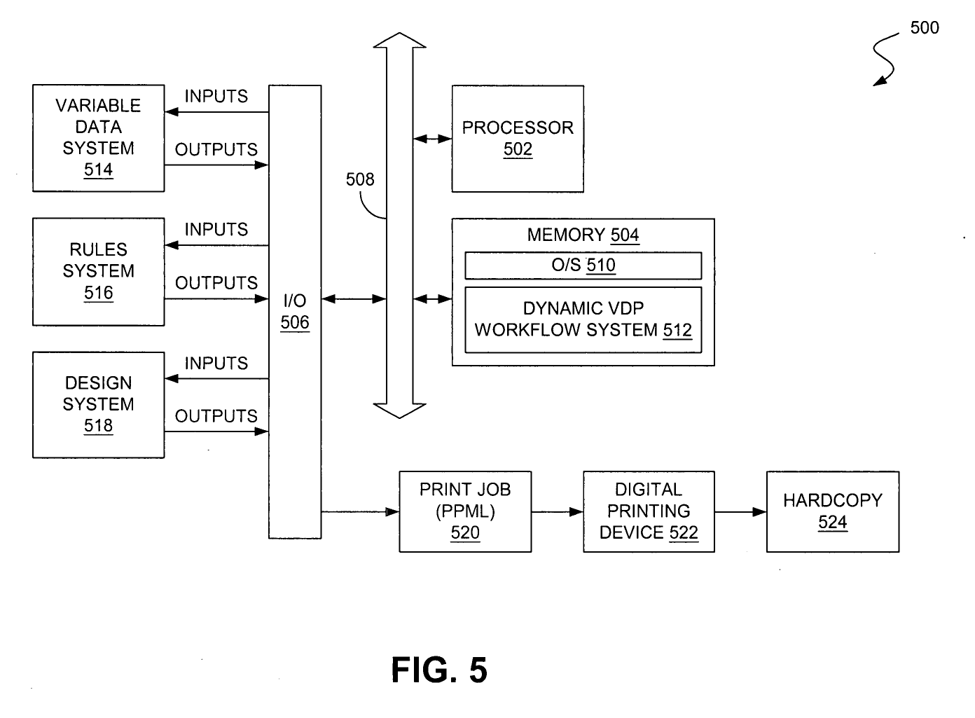

In alternative embodiments, one or more of the aforementioned systems could be implemented in software as an executable program(s). For example, such a system can be executed by a special or general purpose digital computer. An example of a general purpose computer that can implement such a system is shown schematically in FIG. 5.

Generally, in terms of hardware architecture, computer 500 includes a processor 502, memory 504, and one or more input and/or output (I/O) devices 506 (or peripherals) that are communicatively coupled via a local interface 508. The software in memory 504 can include one or more separate programs, each of which comprises an ordered listing of executable instructions for implementing logical functions. In the example of FIG. 5, the software in the memory 504 includes an operating system (O/S) 510, and an embodiment of a dynamic VDP workflow system 512.

When an embodiment of a dynamic VDP workflow system 512 is implemented in software, it should be noted that such a system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. An embodiment of a dynamic VDP workflow system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In operation, the variable data system 514, the rules system 516 and the design system 518 provide outputs that are stored in memory associated with the dynamic VDP workflow system 512. As needed, the dynamic VDP workflow system provides information corresponding to the previously stored inputs to the system(s), e.g., design system 518, requiring the information. Thus, the workflow process is decentralized, in that one portion of the VDP campaign does not need to wait for information provided by another portion of the campaign.

Once all of the various information is acquired by the dynamic VDP workflow system 512, the dynamic VDP workflow system merges the information into the desired format for printing. Typically, the print job, e.g., print job 520, is provided in PPMLT format converted to PPML format, and then provided to a digital printing device. In the embodiment of FIG. 5, printing device 522 receives the print job and, in response thereto, provides hardcopy 524.

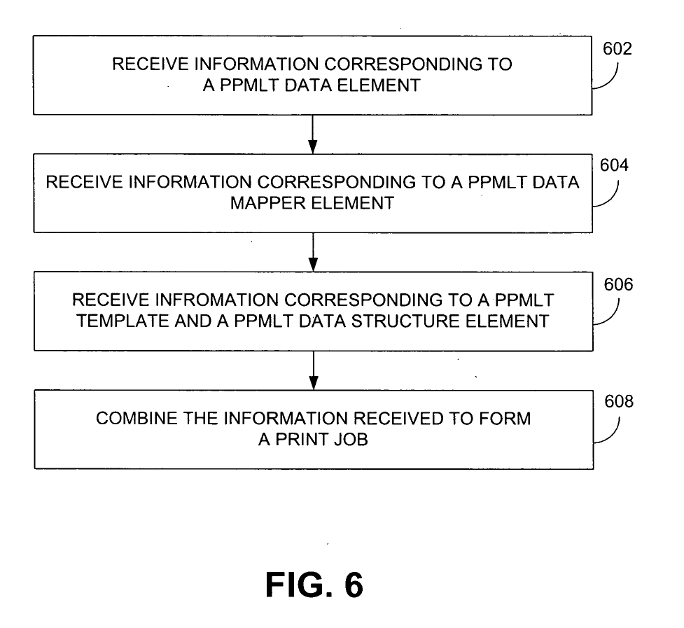

Reference will now be made to FIG. 6, which is a flowchart depicting functionality associated with the embodiment of the dynamic VDP workflow system of FIG. 5. It should be noted that process steps or blocks in the flowcharts of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed. For example, in some embodiments, functions represented in the flowcharts in successive blocks may be executed substantially concurrently, or in reverse order, depending on the functionality involved.

As shown in FIG. 6, the functionality (or method) may be construed as beginning at block 602, where information corresponding to a PPMLT data element is received. In block 604, information corresponding to a PPMLT data mapper element is received. In block 606, information corresponding to a PPMLT template and PPMLT data structure element is received. In block 608, the information received is combined to form a print job. For example, the information can be combined to form a PPMLT file(s), which can be converted to a PPML print job.

It should be emphasized that many variations and modifications may be made to the above-described embodiments. All such modifications and variations are intended to be included herein within the scope of this disclosure and protected by the following claims.

1. A method for performing variable data printing, said method comprising:
defining independent portions of a variable data print (VDP) campaign such that the VDP campaign includes a design portion, a rules portion and a variable data portion; and
defining inputs and outputs associated with each of the portions of the VDP campaign.

2. The method of claim 1, wherein the outputs for the variable data portion of the variable data print campaign comprise a Personalized Print Markup Language Template (PPMLT) data element.

3. The method of claim 2, wherein the outputs for the variable data portion of the variable data print campaign additionally comprise a first PPMLT data structure element.

4. The method of claim 1, wherein the outputs for the design portion of the VDP campaign comprise a PPMLT template.

5. The method of claim 4, wherein the outputs for the design portion of the VDP campaign additionally comprise a second PPMLT data structure element.

6. The method of claim 4, wherein the outputs for the rules portion of the VDP campaign comprise data formatted with respect to the PPMLT template.

7. The method of claim 4, wherein the outputs for the rules portion of the VDP campaign comprise a PPMLT data mapper element.

8. The method of claim 7, wherein the outputs for the rules portion of the VDP campaign additionally comprise a third PPMLT data structure element corresponding to an input format of data that is to be used by the PPMLT data mapper element, and a fourth PPMLT data structure element corresponding to an output format of data that is to be provided by the PPMLT data mapper element.

9. The method of claim 1, further comprising:
using the inputs and outputs defined for the rules portion of the VDP campaign such that of the rules portion is prepared independently with respect to at least one of the variable data portion and the design portion.

10. The method of claim 1, further comprising:
using the inputs and outputs defined for the variable data portion of the VDP campaign such that the variable data portion is prepared independently with respect to at least one of the design portion and the rules portion.

11. The method of claim 1, further comprising:
using the inputs and outputs defined for the design portion of the VDP campaign such that the design portion is prepared independently with respect to at least one of the variable data portion and the rules portion.

12. A system for performing variable data printing, said system comprising:
a dynamic variable data print (VDP) workflow system operative to receive information corresponding to independent portions of a VDP campaign, the VDP campaign comprising a design portion, a rules portion and a variable data portion, the dynamic VDP workflow system being further operative to combine the information received to form a Personalized Print Markup Language Template (PPMLT) print job.

13. The system of claim 12, wherein the dynamic VDP workflow system is further operative to convert the PPMLT print job to a Personalized Print Markup Language (PPML) print job.

14. The system of claim 12, wherein the dynamic VDP workflow system comprises computer-executable instructions.

15. The system of claim 14, further comprising:
a processor operative to execute computer-executable instructions; and
memory communicating with the processor, said memory storing the dynamic VDP workflow system.

16. The system of claim 12, further comprising:
a design system operative to communicate information corresponding to the design portion of the VDP campaign to the dynamic VDP workflow system, the information corresponding to the design portion comprising a PPMLT template.

17. The system of claim 12, further comprising:
a variable data system operative to communicate information corresponding to the variable data portion of the VDP campaign to the dynamic VDP workflow system, the information corresponding to the variable data portion comprising a PPMLT data element.

18. The system of claim 12, further comprising:
a rules system operative to communicate information corresponding to the rules portion of the VDP campaign to the dynamic VDP workflow system, the information corresponding to the rules portion comprising a PPMLT data mapper element.

19. The system of claim 12, further comprising:
a digital printing device operative to receive information corresponding to the PPMLT print job from the dynamic VDP workflow system and print the print job as hardcopy.

20. The system of claim 12, further comprising:
means for printing the print job.
